(19) United States
(12) Patent Application Publication
(10) Pub. No.: US 2005/0154622 A1
(43) Pub. Date: Jul. 14, 2005

(54) Method and system of booking airline itineraries and stopovers

(76) Inventor: Avik Chopra, West New York, NJ (US)

Correspondence Address: KENYON & KENYON, ONE BROADWAY, NEW YORK, NY, 10004, US

(21) Appl. No.: 10/916,085

(22) Filed: Aug. 10, 2004

Related U.S. Application Data
(60) Provisional application No. 60/494,372, filed on Aug. 11, 2003.

(51) Int. Cl. G06F 17/60

(52) U.S. Cl. 705/5

(57) ABSTRACT

A method and system of booking a travel route of a journey having a point of origin and a destination, includes receiving a proposed itinerary for the journey, obtaining a list of valid contracts for available carrier space for the journey, determining a second part of the journey between an intermediate point and the destination, and determining a first part of the journey between the point of origin and the intermediate point, in which the second part of the journey is determined before the first part of the journey.

### RELATED APPLICATION INFORMATION

This application claims the benefit and priority of U.S. Provisional Patent Application Ser. No. 60/494,372 filed on Aug. 11, 2003, which is incorporated herein by reference in its entirety.

### BACKGROUND INFORMATION

Airline routing details for non-published fares may be complex, and may involve, for example, multiple airline carriers and multiple connecting and/or stopover points. It is understood that these fares may not presently be handled by existing published fare booking engines due to, for example, the complexities of the fare rules and multiple airline and/or flight connections.

### SUMMARY OF THE INVENTION

An exemplary embodiment and/or exemplary method of the present invention provide for building a travel itinerary “backwards” by first determining the segments between a intermediate point (e.g., midpoint) and final destination, followed by one or more other segments. In this regard, the travel itinerary may involve one or more carriers that transport passengers or freight.

The exemplary embodiment and/or exemplary method of building a travel itinerary may be useful, for example, when booking international flights since airline carriers may not fly to and/or from all destinations, including, for example, to and/or from the U.S. Even if they do, they may start from a limited number of cities or gateways in the U.S.

According to an exemplary embodiment and/or exemplary method of the present invention, the main airline flight is first selected, and then one of the connecting airlines is selected to complete the itinerary. There may be a limited number of flights operated by the main carrier, from one or more gateway airports, and a larger number of flights by the participating connecting carriers to those gateways. So once the main airline flight choice is selected from all available flight choices from multiple gateway airports, the task of finding an available connecting carrier flight may be simplified, since valid connections to all gateways no longer need to be checked and matched.

The exemplary embodiment and/or exemplary method may also permit or provide for user selection of stopovers, up to four, for example, including such particulars as the city and/or date. In this regard, the user may be presented, for example, with selection choices on a single screen, with any applicable stopover charges updated on the same screen, as the user makes a selection. In particular, the user may specify stopovers from the choices available in the fare rules at each stopover point in the itinerary.

An exemplary embodiment and/or exemplary method may provide the user with the ability to find available flights more easily, in less time, and with fewer system search resources, which may be desired when more than one connecting carrier is allowed and multiple gateways exist for connecting with the main international airline. The exemplary method may be used to reduce the number of permutations and/or combinations that may need to be considered when searching for available connecting flights that comply with all applicable rules and restrictions.

An exemplary embodiment and/or exemplary method may be used to automatically take care of the multiple classes of fares allowed for any leg of the journey so that the user is provided with the lowest fare possible based on the seats and class of fare available. In this regard, a class of fare or service is a semi-arbitrary division of seats sold in the same cabin of an aircraft, designed to maximize revenue for the airline, by charging different fares based on when the purchase is made in relation to the flight date, and in the case of a round-trip, the return date.

An exemplary embodiment and/or exemplary method may be implemented on any suitable processing arrangement, including, for example, a computer, together with a suitable interface, display, and/or input arrangement, and may be performed in an Internet or other network arrangement.

An exemplary embodiment and/or exemplary method is directed to booking a travel route of a journey having a point of origin and a destination, which includes receiving a proposed itinerary for the journey, obtaining a list of valid contracts for available carrier space for the journey, determining a second part of the journey between an intermediate point and the destination, and determining a first part of the journey between the point of origin and the intermediate point, in which the second part of the journey is determined before the first part of the journey.

Another exemplary embodiment and/or exemplary method is directed to a system for booking a travel route of a journey having a point of origin and a destination, including a terminal arrangement having a user interface to receive a requested itinerary for the journey, a database arrangement which includes contracts for available carrier space for the journey; and a server to determine a list of valid contracts for the requested itinerary, a second part of the journey between an intermediate point and the destination, and a first part of the journey between the point of origin and the intermediate point, in which the second part of the journey is determined before the first part of the journey.

An exemplary embodiment and/or exemplary method is directed to a storage medium having a computer program, which is executable by a processor arrangement, which includes computer program code for receiving a proposed itinerary for a journey having a point of origin and a destination, obtaining a list of valid contracts for available carrier space for the journey, determining a second part of the journey between an intermediate point and the destination, and determining a first part of the journey between the point of origin and the intermediate point, in which the second part of the journey is determined before the first part of the journey.

### BRIEF DESCRIPTION OF THE DRAWINGS

FIG. 1 shows an exemplary system for booking a travel route.

FIG. 2 shows an exemplary logical representation for a travel route.

FIG. 3 shows an exemplary method for booking a travel route using the exemplary system of FIG. 1.

FIG. 4 shows an exemplary fare search page for selecting fare search criteria for a proposed travel itinerary.

FIG. 5 shows an exemplary search results page for displaying a list of valid contracts based on the fare search criteria obtained from the exemplary fare search page of FIG. 4.

FIG. 6 shows an exemplary midpoint-destination flight availability page for displaying the available flights for the second part of the journey between a main airline carrier gateway and the final destination.

FIG. 7 shows an exemplary origin-midpoint flight availability page for displaying the available flights for the first part of the journey between the point of origin and the main airline carrier gateway.

FIG. 8 shows an exemplary book flight page to display a complete itinerary of flights selected from the midpoint-destination flight availability page of FIG. 6 and the origin-midpoint flight availability page of FIG. 7.

FIG. 9 shows an exemplary fare search page 900 for selecting fare search criteria, in which a stopover is desired.

FIG. 10 shows an exemplary search results page displaying a list of valid contracts based on the fare search criteria obtained from the exemplary fare search page of FIG. 9.

FIG. 11 shows an exemplary stopover selection page for selecting the location and dates for stopovers.

FIG. 12 shows an exemplary stopover summary page displaying the stopover details for stopovers selected in the exemplary stopover selection page of FIG. 11.

### DETAILED DESCRIPTION

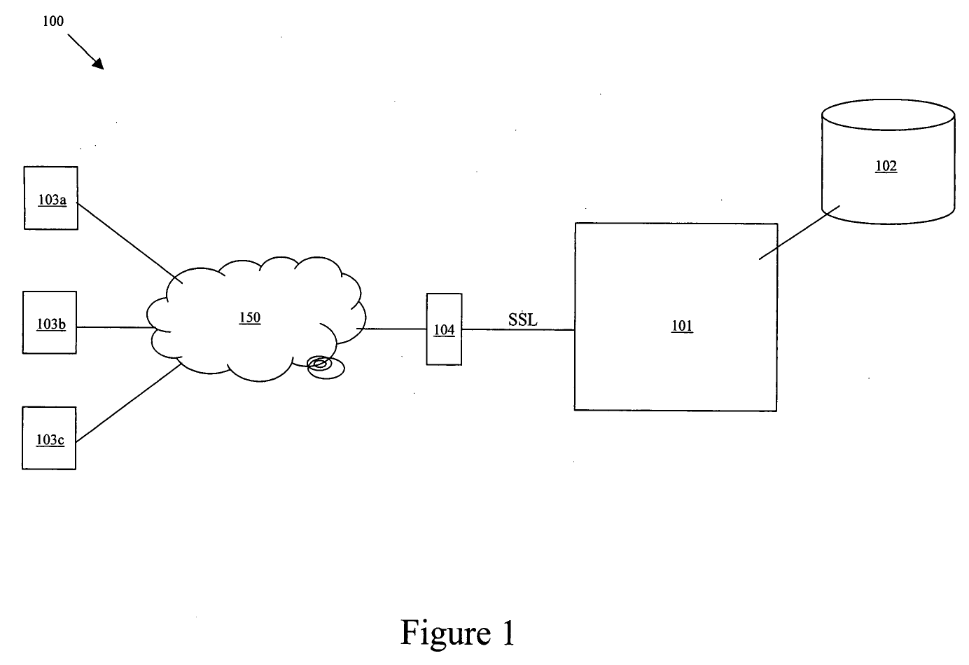

FIG. 1 shows an exemplary system 100 for booking a travel route, including, for example, an airline travel route. The exemplary system 100 may be made accessible to users, such as, for example, travel agents.

The exemplary system 100 includes a server arrangement 101, a database arrangement 102, one or more user interface terminals 103, and a firewall arrangement 104. The server arrangement 101 provides a computer-implemented software application to book complex travel routes that involve multiple airline carriers, multiple airline reservations and/or ticketing. In this regard, the software application may be networked with the user interface terminals 103a, 103b, and 103c, and therefore accessible in a distributed manner to via a suitable data network 150, such as, for example, the Internet. In particular, the exemplary system 100 may utilize the “Microsoft NET” set of technologies. The exemplary system 100 may also employ standard encryption techniques to ensure data integrity, including, for example, the implementation of the Rivest-Shamir-Adelman (RSA) public key encryption algorithm, or a Secure Socket Layer (SSL) between the server 101 and the user interface terminals 103.

The database 102 includes information regarding non-published contract fares, sometimes referred to as “consolidator fares”, or more simply “contracts”, which detail an agreement whereby an airline carrier sells large blocks of seats at a discount for resale by a third party (e.g., a consolidator), who resells that space, usually at a discount from the published fare, that is, the fare specifically listed in the carrier's tariff. In this regard, the contract may include certain rules and restrictions, including, for example, rules and restrictions regarding the permitted dates of travel, minimum stays, and surcharges. The database 102 may be implemented, for example, as a Microsoft SQL server (SQL is short for Structured Query Language, which is ANSI and ISO standard language for relational databases).

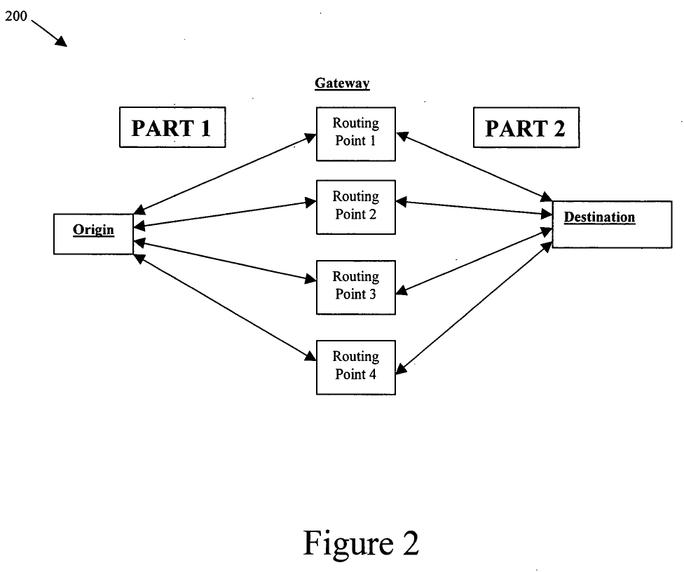

FIG. 2 shows an exemplary logical representation 200 for a travel route from a point of origin to a final destination. In this instance the travel route includes two parts: a first part (Part 1) from the origin to one or more gateways along the route, and a second part (Part 2) from the one or more gateways to the final destination. Here, for example, a gateway (or midpoint or intermediate point) may be a major airport that serves an airline's entry or departure point to or from a country, and may serve as a connecting point with other airlines or flights.

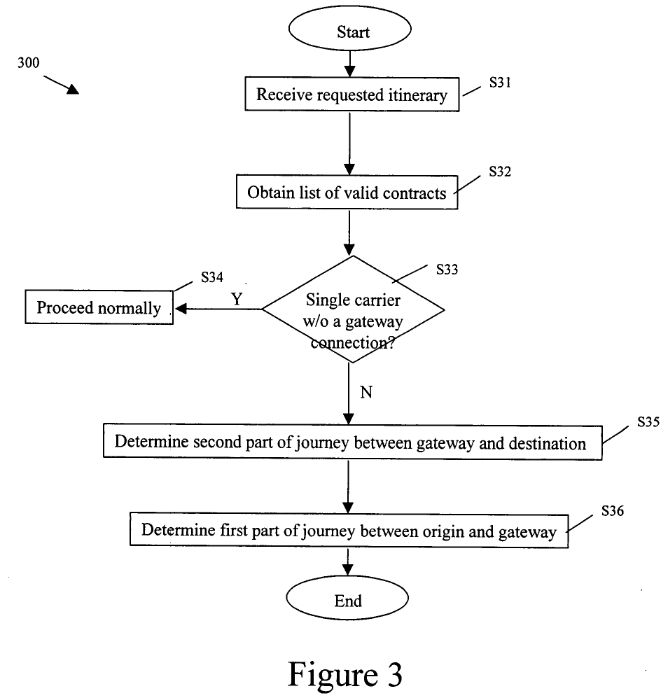

FIG. 3 shows an exemplary method 300 for booking a travel route using the exemplary system 100 of FIG. 1. In step S31, the system 100 receives input from the user 150 regarding a requested itinerary and associated details, which may include, for example, an origin, a destination, preferred travel dates and/or preferred locations for departure and/or arrival. In this regard, the dates may include, for example, a calendar date and/or time of day, and the locations may include, for example, a city or airport.

In step S32, the system 100 obtains a list of valid contracts from the database 102 based on the search criteria provided by the user. A contract, sometimes referred to as “non-published fare” or “consolidator fare,” is an agreement whereby an airline sells large blocks of seats at a discount for resale by a third party (e.g., a consolidator), who resells that space, usually at a discount. The contract may include, for example, detailed flight information, a listed fare, and any surcharges, if applicable. In this regard, a contract is deemed valid if it meets the search criteria and complies with all applicable rules and regulations.

In step S33, if a contract includes only one airline carrier without an intermediate or gateway connection, then the exemplary method 300 proceeds normally (e.g., book requested itinerary based on point to point connection) in step S34. Otherwise, if the contract includes more than one airline carrier or a gateway connecting point, the exemplary method 300 proceeds to step S35.

In step S35, the second part of the journey between a gateway of the main airline and the destination is determined. In this regard, the system 100 may present to the user a choice of main airline. Also, if the main airline has more than one gateway, then available flights from each gateway to the destination are presented to the user as well.

In step S36, the first part of the journey between the origin and the gateway is determined so that a complete itinerary for the entire journey may be built. In this regard, the system 100 may present to the user all available connecting carrier flights from the origin to the chosen gateway.

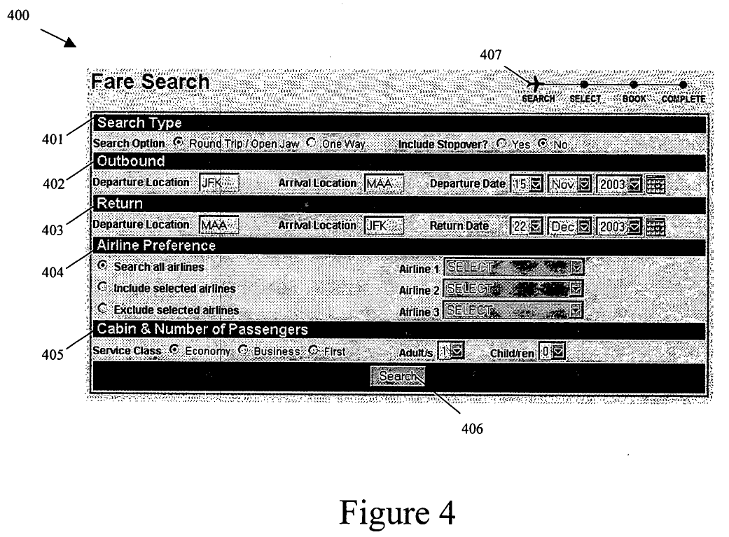

FIG. 4 shows an exemplary fare search page 400 for selecting fare search criteria for a proposed travel itinerary. The exemplary fare search page 400 includes a search type input area 401 to indicate if a round trip or one-way ticket is desired, and if a stopover is desired. In this instance, FIG. 4 shows that a stopover is not desired. The exemplary fare search page 400 also includes an outbound input area 402 to indicate a departure location, an arrival location, and a departure date. The exemplary fare search page 400 also includes a return input area 403 to indicate a departure location, an arrival location, and a return date. The exemplary fare search page 400 also includes an airline preference input area 404 to indicate a preference to search all airlines, to include selected airlines, or to exclude selected airlines, in which up to three airlines may be selected for inclusion or exclusion. The exemplary fare search page 400 also includes a “Cabin & Number of Passengers” input area 405 to indicate a desired service class, a number of adult passengers, and a number of children passengers. The exemplary fare search page 400 also includes a Search button 406 to initiate the search based on the inputted search criteria. The exemplary fare search page 400 also includes a booking status indicator 407 to indicate the current booking status, which, in this instance, is “Search”.

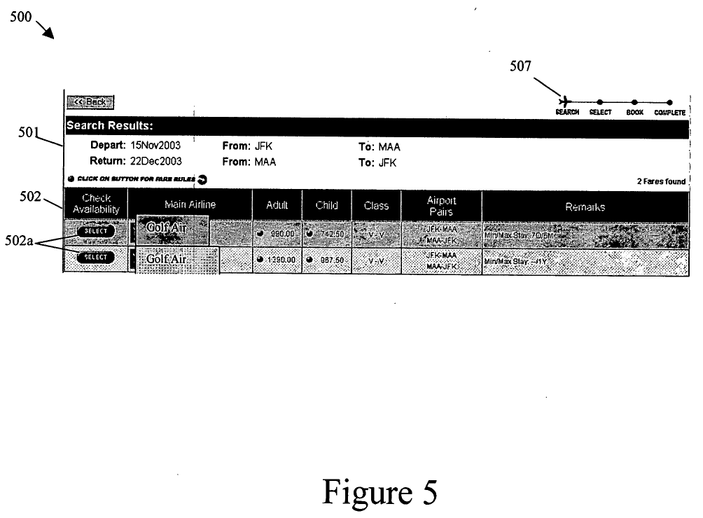

FIG. 5 shows an exemplary search results page 500, which displays of a list of valid contracts based on the fare search criteria obtained from the exemplary fare search page 400 of FIG. 1. The exemplary search results page 500 includes a departure/return display area 501 to display the previously specified departure and return criteria, and a contract display area 502 to display one or more contracts based on the fare search criteria, which were obtained from the exemplary search page 400 of FIG. 1. The contract display area 502 includes a main airline carrier name, an adult fare price, a child fare price, a class of service, airport information, and a remarks field to indicate certain rules or restrictions pertaining the fare/contract. In this instance, the contract display area 502 displays two contracts for the Golf Air main airline carrier. In this regard, Golf Air may be, for example, a middle-eastern airline that flies to a number of destinations in Asia and Europe, but does not fly to and from the U.S. Golf Air may, however, offer non-published fares from cities in the U.S to their destinations, and may provide a choice of different airlines to connect from the U.S. to their European gateways from where the passenger connects onto a Golf Air flight going to one of several cities in the Middle East, and/or connecting on to the final destination, which could be in Asia or the Far East. The contracts display area 502 also includes a select button 502a to select a contract. The exemplary search results page 500 also includes a booking status indicator 507 to indicate the current booking status, which, in this instance, is “Search”.

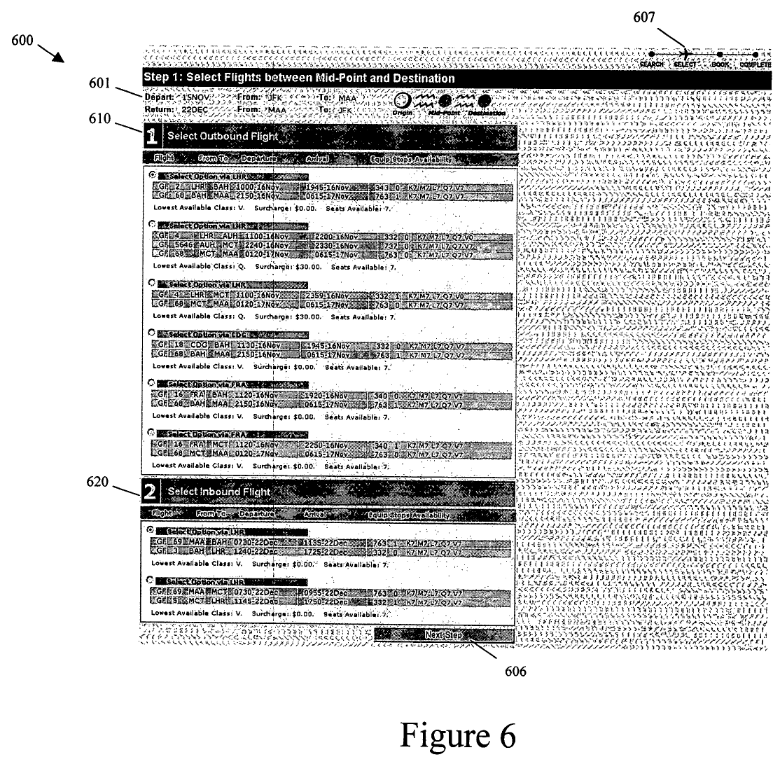

FIG. 6 shows an exemplary midpoint-destination flight availability page 600, which displays the available flights for the second part of the journey between the main carrier gateways (i.e., midpoint) and the destination. The exemplary midpoint-destination flight availability page 600 includes a departure/return display area 601 to display the previously specified departure and return criteria, an outbound flight selection area 610 to select an outbound flight, and an inbound flight selection area 620 to select an inbound flight. The outbound or inbound flights may be displayed, for example, in order of lowest available class, and may include the carrier, the flight, departure and arrival time, connecting information, aircraft or equipment type, and availability based on class of service. The outbound flight selection area 610 includes flights that originate at the midpoint (gateway) and arrive at the destination. In this instance, FIG. 6 shows that six outbound flights are available. The inbound flight selection area 620 includes flights that originate from the destination to the midpoint (gateway). In this regard, FIG. 6 shows that two inbound flights are available. The exemplary midpoint-destination flight availability page 600 also includes a booking status indicator 607 to indicate the current booking status, which, in this instance is displayed as “Select”. The exemplary midpoint-destination flight availability page 600 also includes a Next Step button 606 so that the user may continue the booking process.

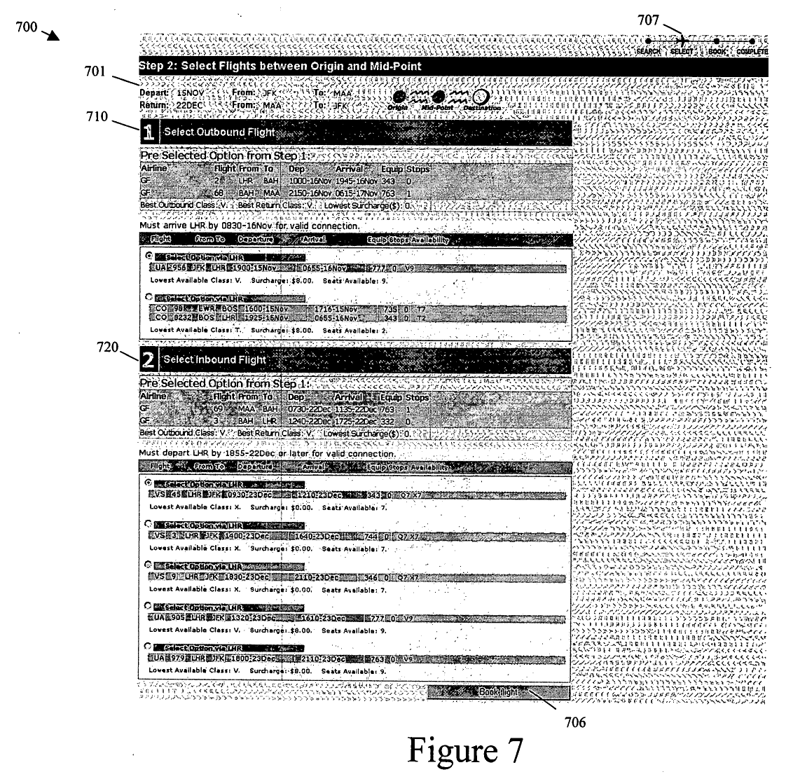

FIG. 7 shows an exemplary origin-midpoint flight availability page 700, which displays the available flights for the first part of the journey between the origin and a midpoint along the journey. The exemplary origin-midpoint flight availability page 700 includes a departure/return display area 701 to display the previously specified departure and return criteria, an outbound flight selection area 710 to select an outbound flight, and an inbound flight selection area 720 to select an inbound flight. The outbound or inbound flights may be displayed, for example, in order of lowest available class, and may include the carrier, the flight, departure and arrival time, connecting information, aircraft or equipment type, and availability based on class of service. The outbound flight selection area 710 includes flights that originate at the point of origin and arrive at the midpoint (gateway). In this instance, FIG. 7 shows that two outbound flights are available. The inbound flight selection area 720 includes flights that originate from the midpoint (gateway) and arrive at the origin. In this regard, FIG. 7 shows that five inbound flights are available. The exemplary origin-midpoint flight availability page 700 also includes a booking status indicator 707 to indicate the current booking status, which, in this instance is displayed as “Select”. The exemplary origin-midpoint flight availability page 700 also includes a Book flight button 706 so that the user may indicate their desire to book their selected flights.

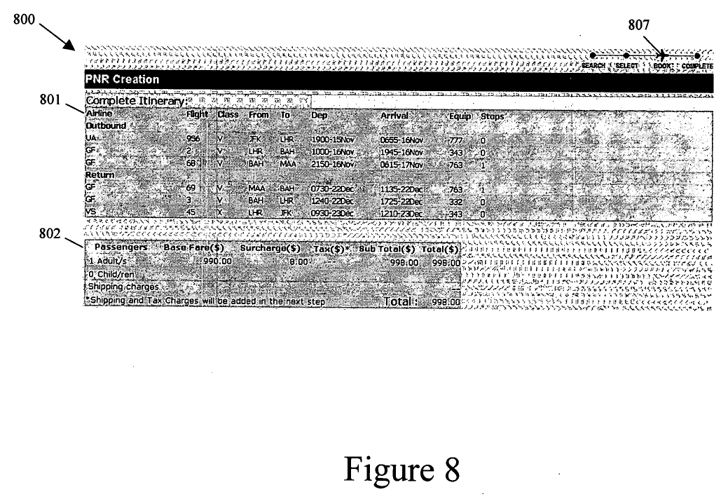

FIG. 8 shows an exemplary book flight page 800, which displays the entire itinerary of flights selected from the midpoint-destination flight availability page 600 and from the origin-midpoint flight availability page 700. In particular, the exemplary book flight page 800 includes a flight details area 801 to display details regarding the outbound and return flights of the journey, and a fare details area 802 to display details regarding the total cost of travel. The exemplary book flight page 800 also includes a booking status indicator 807 to indicate the current booking status, which, in this instance, is “Book”.

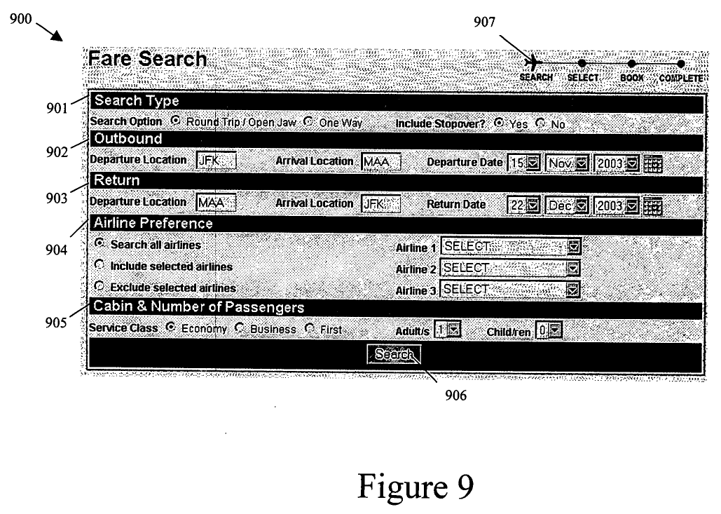

FIG. 9 shows an exemplary fare search page 900 for selecting fare search criteria, which is similar to the exemplary fare search page 400 of FIG. 4 except that, in this instance, the search type input area 901 indicates that a stopover is desired. In all other respects, the exemplary fare search page 900 is identical. In particular, the exemplary fare search page 900 includes an outbound input area 902 to indicate a departure location, an arrival location, and a departure date. The exemplary fare search page 900 also includes a return input area 903 to indicate a departure location, an arrival location, and a return date. The exemplary fare search page 900 also includes an airline preference input area 904 to indicate a preference to search all airlines, to include selected airlines, or to exclude selected airlines, in which up to three airlines may be selected for inclusion or exclusion. The exemplary fare search page 900 also includes a cabin & number of passengers input area 905 to indicate a desired service class, a number of adult passengers, and a number of children passengers. The exemplary fare search page 900 also includes a search button 906 to initiate the search based on the inputted search criteria. The exemplary fare search page 900 also includes a booking status indicator 907 to indicate the current booking status, which, in this instance, is “Search”.

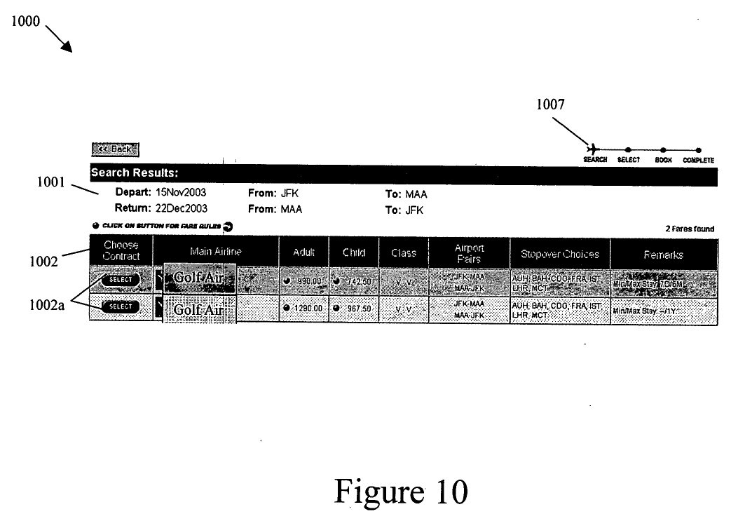

FIG. 10 shows an exemplary search results page 1000, which is similar to the exemplary search results page 500 of FIG. 5 except that the contract display area 1002 further includes a list of stopover choices. In this regard, the exemplary search results page 1000 displays of a list of valid contracts based on the fare search criteria obtained from the exemplary fare search page 900 of FIG. 9. The exemplary search results page 1000 includes a departure/return display area 1001 to display the previously specified departure and return criteria, and a contract display area 1002 to display one or more contracts based on the fare search criteria, which were obtained from the exemplary search page 900 of FIG. 9. The contract display area 1002 includes a main airline carrier name, an adult fare price, a child fare price, a class of service, airport information, a list of stopover choices, and a remarks field to indicate certain rules or restrictions pertaining the fare/contract. In this instance, the contract display area 1002 displays two contracts for the Golf Air main airline carrier. The contracts display area 1002 also includes a select button 1002a to select a contract. The exemplary search results page 1000 also includes a booking status indicator 1007 to indicate the current booking status, which, in this instance, is “Search”.

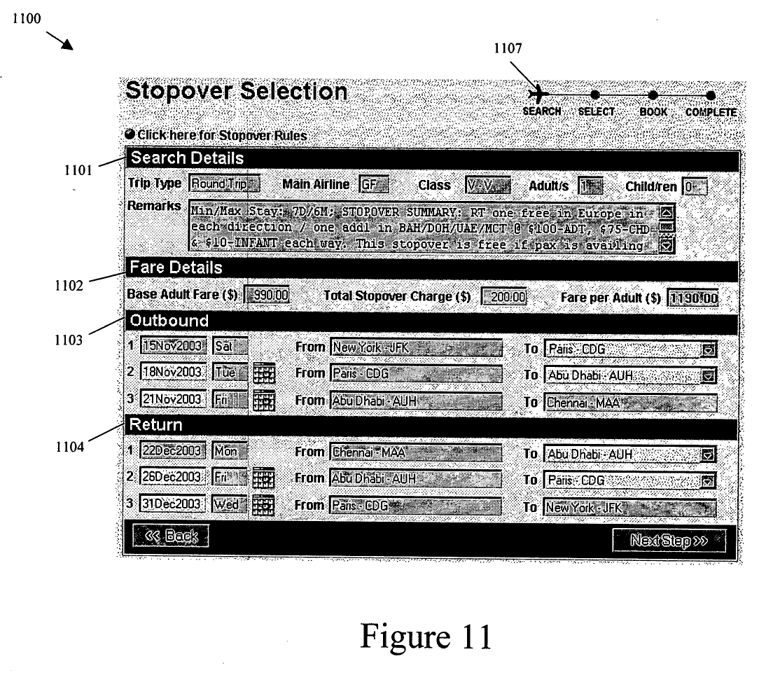

FIG. 11 shows an exemplary stopover selection page 1100 for selecting location and dates for stopovers. The exemplary stopover selection page 1100 includes a search details area 1101 to indicate the selected trip type, main airline, class of service, number of adult passengers, number of children passengers, and a remarks field. The exemplary stopover selection page 1100 also includes a fare details area 1102 to indicate the base adult fare, total stopover charge, and fare per adult. The exemplary stopover selection page 1100 also includes an outbound fight area 1103 to indicate the date and location of the stopover(s) for outbound flights, and a return flight area 1104 to indicate the data and location of the stopover(s) for the return flights. In this regard, up to two valid outbound stopovers and two valid return stopovers may be selected.

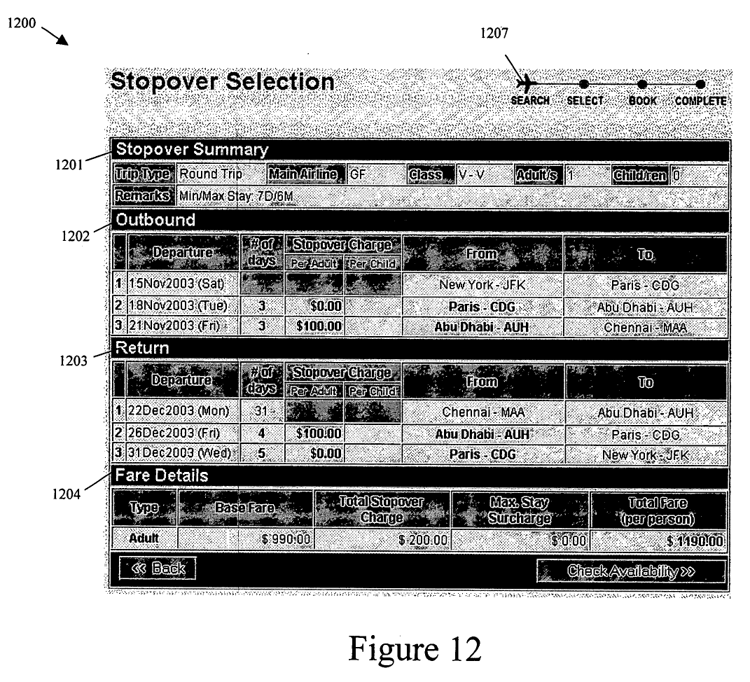

FIG. 12 shows an exemplary stopover summary page 1200, which displays the stopover details for the stopover(s) specified in the exemplary stopover selection page 1100. In this regard, the system 100 dynamically updates stopover charges, and calculates the total charge. The exemplary stopover summary page 1200 includes a stopover summary area 1201 to indicate the selected trip type, main airline, class of service, number of adult passengers, number of child passengers, and remarks. The exemplary stopover summary page 1200 also includes an outbound flight area 1202 to display the stopover details for the outbound flight, and a return flight area 1203 to display the stopover details for the return flight, which include, for example, the departure dates and locations, length of stay for each stopover, and the charge for each stopover. The exemplary stopover summary page 1200 also includes a fare details area 1204 to display to the details regarding the base fare, total stopover charge, maximum stay surcharge, and total fare per person.

1. A method of booking a travel route of a journey having a point of origin and a destination, comprising:
receiving a proposed itinerary for the journey;
obtaining a list of valid contracts for available carrier space for the journey;
determining a second part of the journey between an intermediate point and the destination; and
determining a first part of the journey between the point of origin and the intermediate point, wherein the second part of the journey is determined before the first part of the journey.

2. The method of claim 1, wherein the list of valid contracts includes available carrier space provided by at least one main carrier and at least one connecting carrier.

3. The method of claim 2, wherein the available carrier space provided by the at least one main carrier includes available carrier space for the second part of the journey, and the available carrier space provided by the at least one connecting carrier includes available carrier space for the first part of the journey.

4. The method of claim 3, wherein the at least one main carrier and the at least one connecting carrier are airline carriers.

5. The method of claim 2, further comprising:
providing a choice for the at least one main carrier; and
providing a choice of the intermediate point.

6. The method of claim 5, further comprising:
providing a choice for an inbound and outbound leg for the second part of the journey; and
providing a choice for an inbound and outbound leg for the first part of the journey.

7. The method of claim 5, further comprising:
providing a choice for at least one stopover.

8. The method of claim 5, wherein the choice for at least one stopover includes a choice of stopover for an outbound and return portion for each of the first and second part of the journey.

9. The method of claim 5, further comprising:
providing a choice for at least four stopovers.

10. A system for booking a travel route of a journey having a point of origin and a destination, comprising:
a terminal arrangement having a user interface to receive a requested itinerary for the journey;
a database arrangement which includes contracts for available carrier space for the journey; and
a server to determine a list of valid contracts for the requested itinerary, a second part of the journey between an intermediate point and the destination, and a first part of the journey between the point of origin and the intermediate point, wherein the second part of the journey is determined before the first part of the journey.

11. The system of claim 10, wherein the available carrier space for the journey is provided by at least one main carrier and at least one connecting carrier.

12. The system of claim 10, wherein the available carrier space provided by the at least one main carrier includes available carrier space for the second part of the journey, and the available carrier space provided by the at least one connecting carrier includes available carrier space for the first part of the journey.

13. The system of claim 10, wherein the at least one main carrier and the at least one connecting carrier are airline carriers.

14. The system of claim 10, wherein the system is configured as a web-based application.

15. The system of claim 10, wherein the server is accessible via a network.

16. The system of claim 15, wherein the network includes the Internet.

17. The system of claim 10, wherein the user interface is configured to receive a preference for at least one stopover.

18. The system of claim 10, wherein the user interface is configured to receive a preference for the intermediate point.

19. A storage medium having a computer program, which is executable by a processor arrangement, comprising:
computer program code for performing the following:
receiving a proposed itinerary for a journey having a point of origin and a destination;
obtaining a list of valid contracts for available carrier space for the journey;
determining a second part of the journey between an intermediate point and the destination; and
determining a first part of the journey between the point of origin and the intermediate point, wherein the second part of the journey is determined before the first part of the journey.

20. A method for booking an air travel route, comprising:
receiving fare search criteria regarding a proposed journey having a point of origin and a destination;
providing a choice of a main airline carrier and a gateway served by the main airline carrier;
providing a choice for outbound and inbound flights of the main carrier between the gateway and the destination;
providing a choice for outbound and inbound flights of a connecting airline carrier between the point of origin and the gateway, wherein the choice for outbound and inbound flights of the main carrier between the gateway and the destination is provided before the choice for outbound and inbound flights of the connecting airline carrier between the point of origin and the gateway; and
providing a choice of date and location for at least one stopover.
